(19) United States
(12) Patent Application Publication
(10) Pub. No.: US 2003/0055702 A1
(43) Pub. Date: Mar. 20, 2003

(54) System and method for estimating and planning website development

(75) Inventor: Kenneth Wayne Waterston, Arlington, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/957,514

(22) Filed: Sep. 20, 2001

(51) Int. Cl. G06F 17/60

(52) U.S. Cl. 705/8

(57) ABSTRACT

A system and method for generating a project plan based on determining dependencies between creative requirements and technical requirements is presented. A website project is identified which includes a plurality of Web pages and one or more executable objects. Dependencies between the Web pages and the executable object are analyzed, and a project plan is generated corresponding to the Web page requirements and the executable object requirements. Hourly run rates may be entered and a total project cost may be determined based on the hourly run rates and the total hours estimated to complete the project.

### BACKGROUND OF THE INVENTION

1. Technical Field

The present invention relates in general to a method and system for generating a project plan. More particularly, the present invention relates to a system and method for generating a project plan for website development using automated dependency techniques.

2. Description of the Related Art

The Internet has created tremendous opportunities for businesses. Large companies and small companies may reach customers around the world by advertising on the Internet. A companies' website is a fundamental instrument in advertising on the Internet. The website should make sense from a customer perspective and be neat, orderly, and easy to navigate. The Internet is a user-driven, interactive medium and a customer may choose which Web page he wants to view. By having a well structured website, a customer may have an enjoyable experience and buy product. On the other hand, if the website is unorganized, the customer may not be able to find what he is looking for and purchase the product from another company.

A website includes Web page files and executable object files. A Web page file is usually designed by a Web page designer and includes links to other Web pages and buttons that activate an executable file to perform an action. An executable file is a file that performs a specific function and is usually designed by a programmer, such as a Java programmer. The same executable file may be associated with multiple Web page files. For example, a search engine uses an executable file to look up locations in a website which includes what the customer entered in the search field. The company may decide to allow a customer to use the search engine on each Web page in the companies' website.

A navigation strategy is important when designing a website. A company website may include hundreds of Web pages, and a customer could easily get lost in the website if the website is not organized properly. For example, a navigation strategy may specify the most common customer interest areas and include links to those areas in the companies' “Home” page. The navigation strategy may also specify that customers prefer access to a search engine on every Web page in order to move though the website quickly. As the navigation strategy becomes more detailed, the website may become larger in order to provide additional features for a more enjoyable customer experience.

As a website gets larger, the dependencies between the Web pages and executable files become more complex. A challenge found with designing a website is that the dependencies make planning a website project difficult. Project planning becomes time consuming and often does not identify the Web pages or executable files that should be designed first. Web designers and Java programmers may create the easiest and most enjoyable Web page or executable file first. However, the Web pages chosen by the Web designers and the executable files chosen by the Java programmers may not be the most important ones to complete first. Consequently, an initial website project may end up with many completed Web pages which do not have the associated executable files completed.

What is needed, therefore, is way to efficiently determine dependencies between Web pages and executable files in order to successfully plan a website project.

### SUMMARY

It has been discovered that generating the dependencies between Web pages and executable object files through an automated process reduces project planning time. A website project is identified which includes Web pages and executable object files. For example, a website project may be a companies' new website or an addition to an existing website. The website architecture is structured which may include major areas of customer interest, such as a product information area or online ordering area. Web page, or creative, requirements are analyzed and details concerning such requirements are input into a build estimator engine. Technical, or executable object requirements, are also analyzed and details concerning such requirements are input into the build estimator engine.

Dependencies are ascertained between the Web pages and the executable object files. For example, an executable object file may be associated with multiple Web pages, such as with a search engine. The search engine may be the same executable object code being accessible from multiple Web pages.

The amount of effort, or hours, is calculated to build the Web pages based on the creative inputs and the creative resources available. The amount of effort, or hours, is calculated to build the executable objects based on the technical requirements and the programming resources available. These amounts are entered into the system for planning determinations.

Project costs are generated based on the amount of effort to build the Web pages, the executable objects, and revenue run rates for creative resources and programming resources. The project costs are validated from a top-down approach and refined if required. A project plan is generated based upon the effort involved for the creative requirements and the technical requirements.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is diagram of Website development activities being organized into a creative schedule and a technical schedule;

FIG. 2 is a diagram of a scheduling chart being generated from a dependency matrix;

FIG. 3 is a high level flowchart showing a website project being identified and inputs being processed corresponding to the website project;

FIG. 4 is a flowchart showing creative inputs and associated creative factors being stored;

FIG. 5 is a flowchart showing technical inputs and associated technical factors being stored;

FIG. 6 is a flowchart showing website project inputs being sorted and refined;

FIG. 7 is a flowchart showing a project plan being generated;

FIG. 8 is a flowchart showing a matrix being sorted and various scheduling calculations being performed;

FIG. 9 is a flowchart showing a testing criteria being defined and adjusted;

FIG. 10 is a flowchart showing the generation of a test plan; and

FIG. 11 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

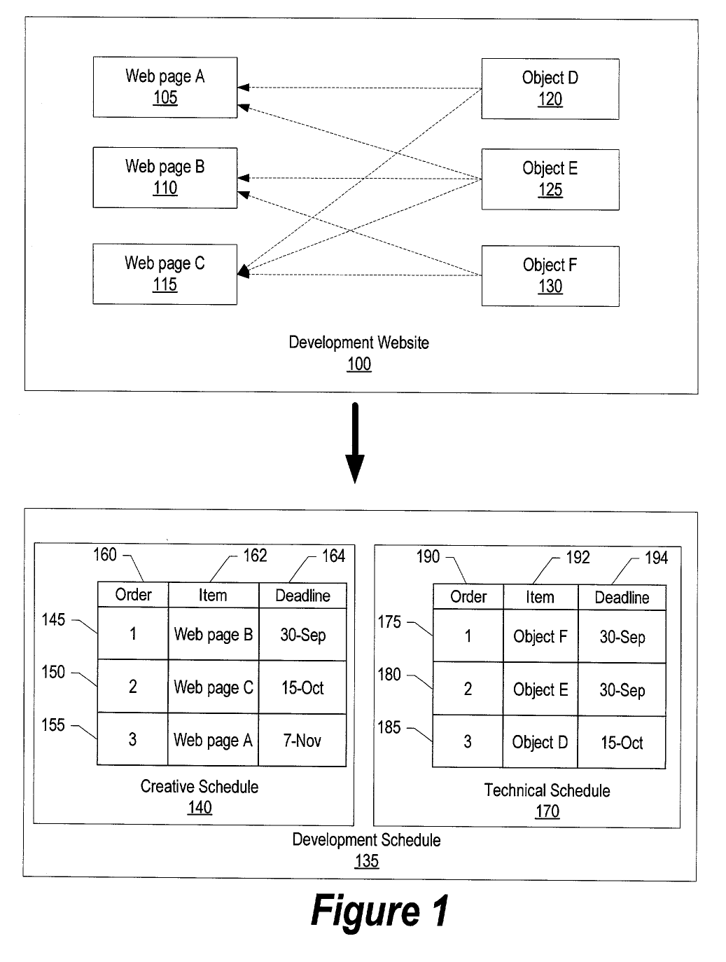

FIG. 1 is diagram of a website development being organized into a creative schedule and a technical schedule. Development website 100 includes Web pages and executable objects that may be associated with each other. For example, a Web page may have an associated executable object that allows a user to perform a certain action through a hyperlink or other means. A company home page may include a search engine which executes a program when the search engine is accessed. The search engine may also be accessed from other Web pages within the website.

Developing a project plan becomes more complex as the dependencies between Web pages and objects increase. In development website 100, Web page A 105 includes dependencies to Object D 120 and Object E 125. Web page B 110 includes dependencies to Object E 125 and Object F 130. Web page C 115 includes dependencies to Object D 120, Object E 125, and Object F 130.

Information about development website 100 may be used to generate development schedule 135. Development schedule 135 includes creative schedule 140 and Technical schedule 170. Since different resources are typically used to design a Web page versus an executable object, different schedules may be generated to effectively utilize the resources. For example, a team of Web designers may be used to develop Web pages, whereas a team of Java programmers may be used to develop executable objects.

Creative schedule 140 includes order 160, item name 162, and deadlines 164. Order 160 specifies the scheduling of the Web pages. Item name 162 specifies the name of the Web page being scheduled corresponding to the order in the same row. Deadlines 164 specifies a deadline of a corresponding item in the same row. Row 145 shows Web page B being first to be designed and is due on September 30th. Row 150 shows Web page C being second to be designed and is due on October 15th. Row 155 shows Web page A being third to be designed and is due on November 7th.

Technical schedule 170 includes order 190, item name 192, and deadline 194. Order 190 specifies the scheduling of the executable objects. Item name 192 specifies the name of the executable object being scheduled corresponding to the order in the same row. Deadlines 194 specifies a deadline of a corresponding item in the same row. Deadlines 194 may not be known prior to generating technical schedule 170. However, deadlines 194 will be determined for each object based on when the associated Web pages are due. Row 175 shows object F being first to be designed and is due on September 30th. Row 180 shows object E being second to be designed and is due on September 30th. Row 185 shows Object D being third to be designed and is due on October 15th.

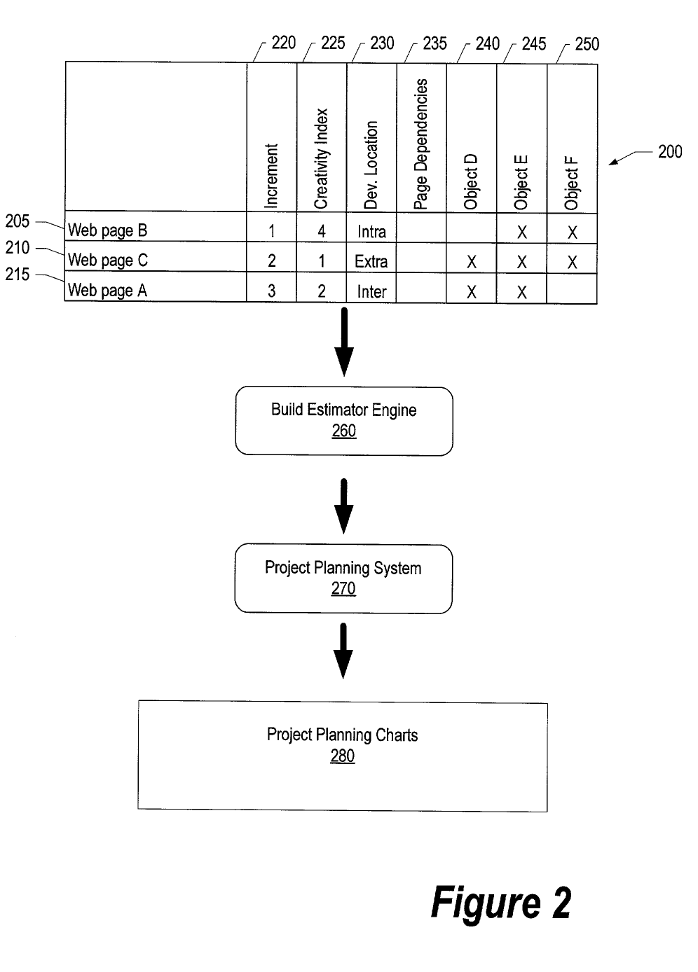

FIG. 2 is a diagram of a scheduling chart being generated from a dependency matrix. Dependency matrix 200 includes dependencies between Web pages and objects. Dependency matrix 200 also includes information such as increment 220, creativity index 225, development location 230, and page dependencies 235. Increment 220 specifies the increment, or phase, during which a particular Web page is due. For example, a project may be split into four phases, each corresponding to a fiscal quarter in a year. Creativity index 225, or creativity difficulty factor, specifies how difficult a particular Web page is to design. For example, a scale between one and four may be used to specify the creativity index, where the scale corresponds to the graphic complexity and production complexity of the Web page.

Development location 230 specifies where the Web page will be viewed. For example, a Web page may be viewed on a company intranet, while another Web page may be viewed on the Internet. The distinction on where the Web page will be viewed can be used in assessing security and the firewall test requirements for a particular Web page. Page dependencies 235 specifies the Web page dependencies of a particular Web page.

Row 205 shows Web page B being scheduled for the first increment; Web page B has a creativity index of four, and is being developed on the Intranet. Row 205 also shows that Web page B is associated with object E 245 and object F 250. Row 210 shows Web page C being scheduled for the second increment; Web page C has a creativity index of 1, and is being developed on an extranet. The extranet may be a customer specific or private network, such as a virtual private network. Row 210 also shows that Web page C is associated with object D 240, object E 245, and object F 250. Row 215 shows that Web page A is scheduled for the third increment; Web page A has a creativity index of 2, and is being developed on the Internet. Row 215 also shows that Web page A is associated with object D 240 and object E 245.

Dependency matrix 200 is received by build estimator engine 260, which processes creative inputs corresponding to Web pages and technical inputs corresponding to objects. The output of build estimator 260 is received by project planning system 270, which generates project planning charts 280 corresponding to the Web pages and objects. Project planning system may be an off-the-shelf software program, such as IBM's Global System Method Program™, or a custom project planning system.

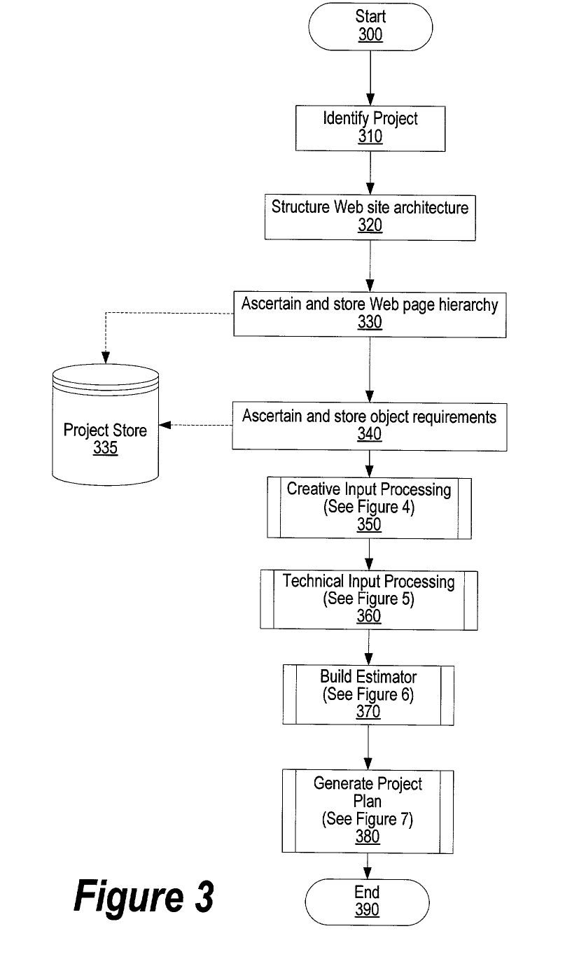

FIG. 3 is a high-level flowchart showing the identification of a website project and inputs being processed corresponding to the website project. Processing commences at 300, whereupon a project is identified (step 310). For example, a project may be a companies' new website or an addition to an existing website. The website architecture is structured at step 320. For example, the architecture may include major areas of customer interest, such as a product information area or online ordering area. The Web page hierarchy is ascertained and stored in Project Store 335 (step 330). The website hierarchy may include the links between Web pages. Executable object requirements are ascertained and stored in Project Store 335 (step 340). For example, executable object requirements may include which options may be in a search engine.

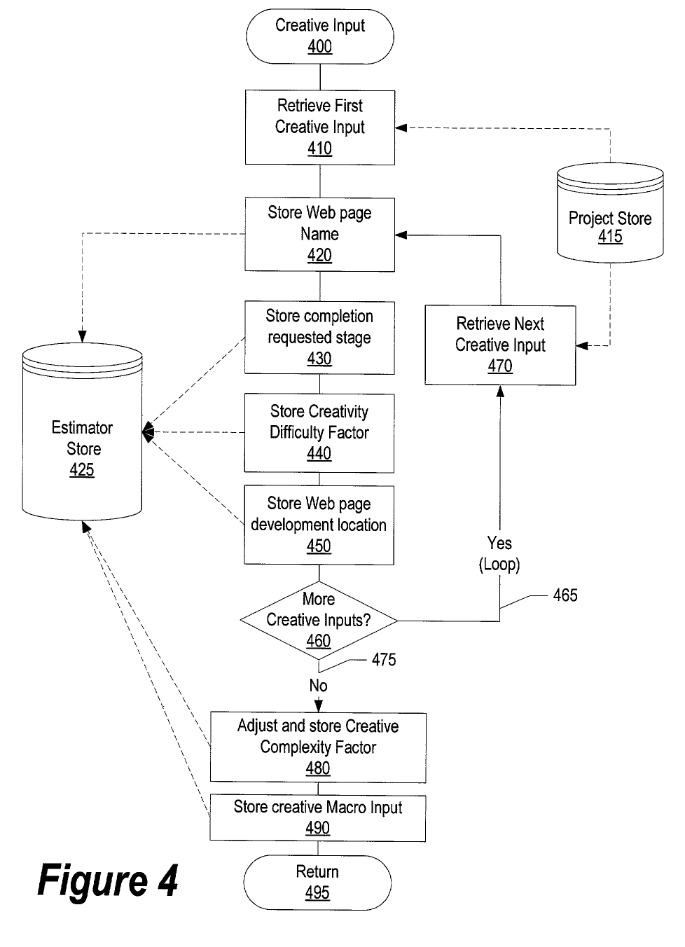

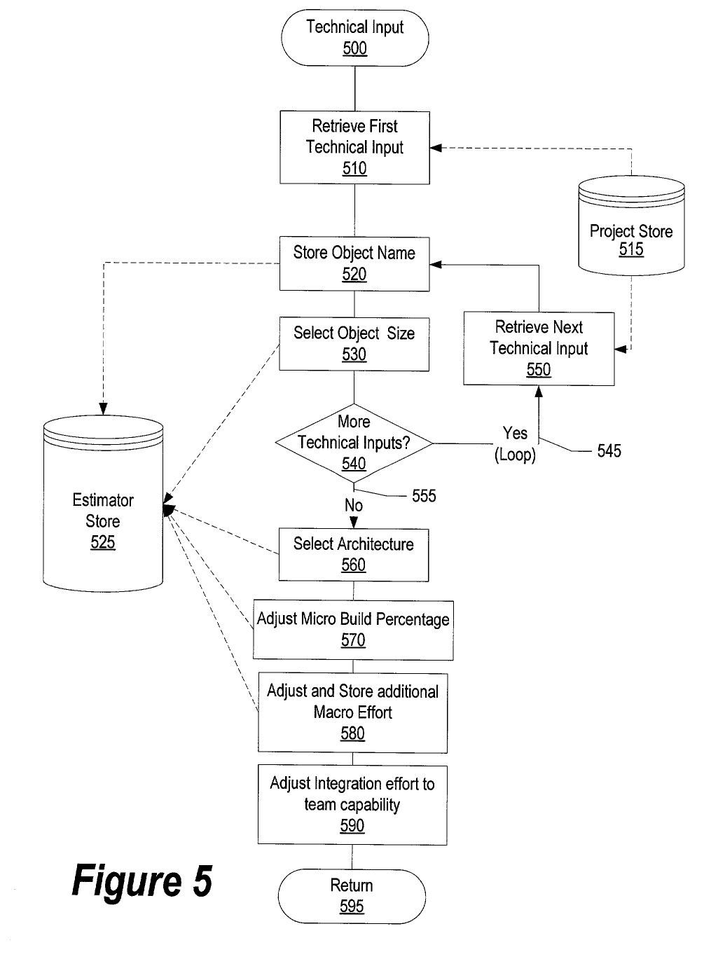

Creative input is processed (pre-defined process block 350, see FIG. 4 for further details) and technical input is processed (pre-defined process block 360, see FIG. 5 for further details). Creative Input processing and Technical Input processing are shown in a serial manner. However, these steps may be done in parallel as well as being performed as iterative processes. For example, input may be processed as it is received, regardless of whether it is creative or technical in nature.

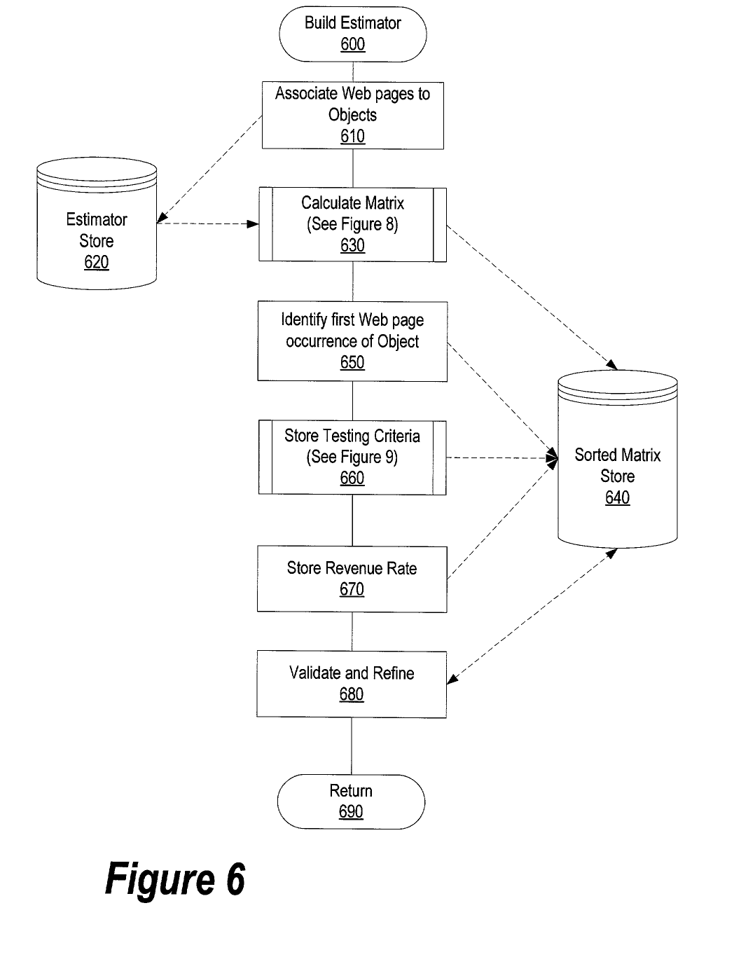

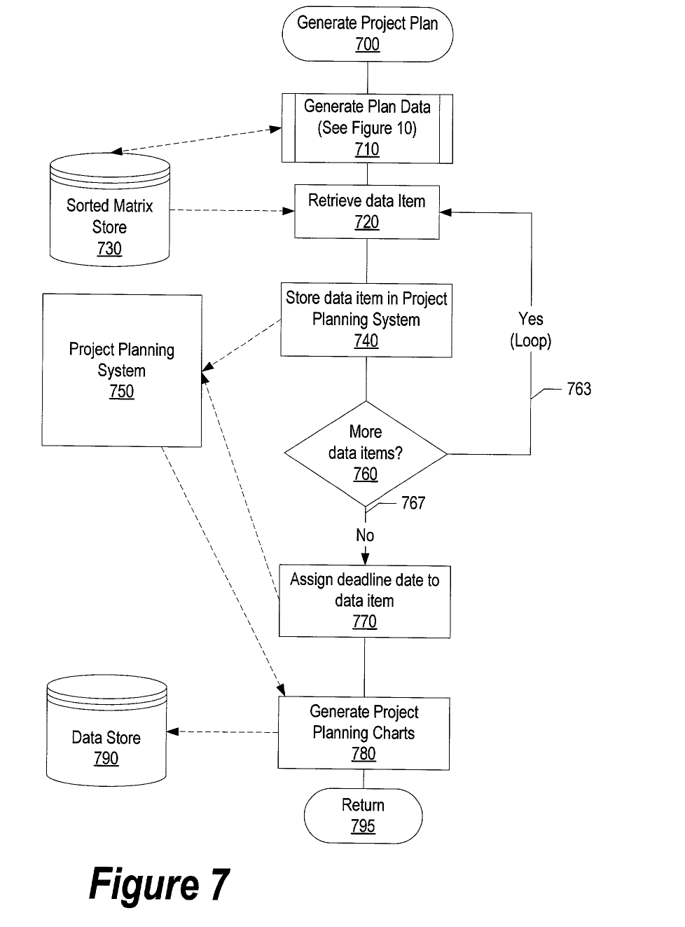

Build estimation is performed (pre-defined process block 370, see FIG. 6 for further details), and a project plan is generated (pre-defined process block 380, see FIG. 7 for further details). Processing thereafter ends at 390.

FIG. 4 is a flowchart showing creative inputs and associated creative factors being stored. Creative input processing commences at 400, whereupon a first creative input is retrieved from project store 415 (step 410). A Web page name corresponding to the first creative input is stored in estimator store 425 (step 420). A completion requested stage corresponding to the first creative input is stored in estimator store 425 (step 430). For example, a project may have three phases in which each phase corresponds to a completion date. The completion requested stage for the first creative input may be in phase one, phase two, or phase three. A creative difficulty factor is stored in estimator store 425 (step 440). The creative difficulty factor is assessed for each page and may be made by selecting a value from a predefined scale. For example, a scale between one and four may be used, where one represents a Web page that is not difficult to build, and four represents a Web page that is more difficult to build.

The Web page development location is stored in estimator store 425 (step 450). For example, the Web page may be developed on the Internet, intranet, or extranet. For each location, various firewall and testing issues may be analyzed.

A determination is made as to whether there are more creative inputs (decision 460). If there are more creative inputs, decision 460 branches to “Yes” branch 465 which loops back and retrieves the next creative input from project store 415 (step 470). This looping continues until there are no more creative inputs, at which point decision 460 branches to “No” branch 475 whereupon the creative complexity factor is adjusted and stored in estimator store 425 (step 480). The creative complexity factor is based on the resources available and the difficulty factor of the Web pages. For example, the creative complexity factor may be high if the Web pages being designed are difficult to build and the design team is inexperienced. A creative macro percentage is stored (step 490). The creative macro percentage is related to how many more creative macro tasks may be discovered during the project. For example, if a project is well defined and most creative tasks are known, the creative macro percentage may be low. Processing returns at 495.

FIG. 5 is a flowchart showing technical inputs and associated technical factors being stored. Technical input processing commences at 500, whereupon a first technical input is retrieved form project store 515 (step 510). An object name corresponding to the first technical input is stored in estimator store 525 (step 520). The object size corresponding to the technical input is stored in estimator store 525 at step 530. For example, a user may choose from an object size selection of small, medium, or large. In another embodiment, a user may specify an estimated code size of the object.

A determination is made as to whether there are more technical inputs to retrieve (decision 540). If there are more technical inputs, decision 540 branches to “Yes” branch 545 which loops back to retrieve the next technical input from project store 515 (step 550). This looping continues until there are no more technical inputs to retrieve, at which point decision 540 branches to “No” branch 555. An architecture environment is selected and stored in estimator store 525 at step 560. For example, a user may have an architecture selection of Microsoft Site Server™, Websphere Application Suite™, or some user defined system.

A micro build percentage is adjusted and stored in estimator store 525 (step 570). The micro build percentage relates to the resources that are available and how much time will be spent analyzing an object versus writing code for the object. For example, an experienced programmer may be able to write code for an object without spending too much time analyzing how to write the code, in which case the micro build percentage will be low. However, an inexperienced programmer may need to spend more time analyzing how to write code for the object, in which case the micro build percentage will be higher.

A technical macro effort percentage is adjusted and stored in estimator store 525 at step 580. The technical macro effort percentage is related to how many more technical macro tasks may be discovered during the project. For example, if a project is well defined and most variables are known, the technical macro effort percentage may be low. On the other hand, if the project is not well defined, many variables may not be known in which case the technical macro effort percentage may be high. Page integration hours are adjusted and stored in estimator store 525 (step 590). Page integration hours are based on the resources available for integration and what is being integrated. For example, an experienced team may be able to integrate difficult objects easily in which case the page integration hours may be low. Processing returns at 595.

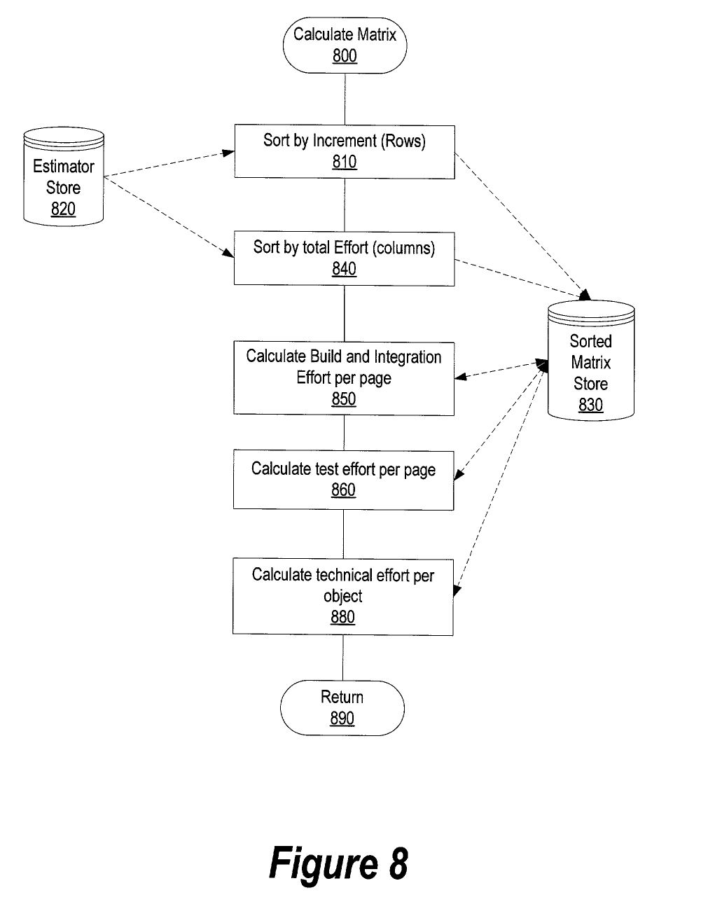

FIG. 6 is a flowchart showing the sorting and refinement of website project inputs. Processing commences at 600, whereupon an association between Web pages and executable objects is stored in estimator store 620 (step 610). For example, the association may include which executable objects may be used on a particular Web page such as through a hyperlink. A matrix is sorted and stored in sorted matrix store 640 (pre-defined process block 630, see FIG. 8 for further details). The matrix includes the association between Web pages and executable objects.

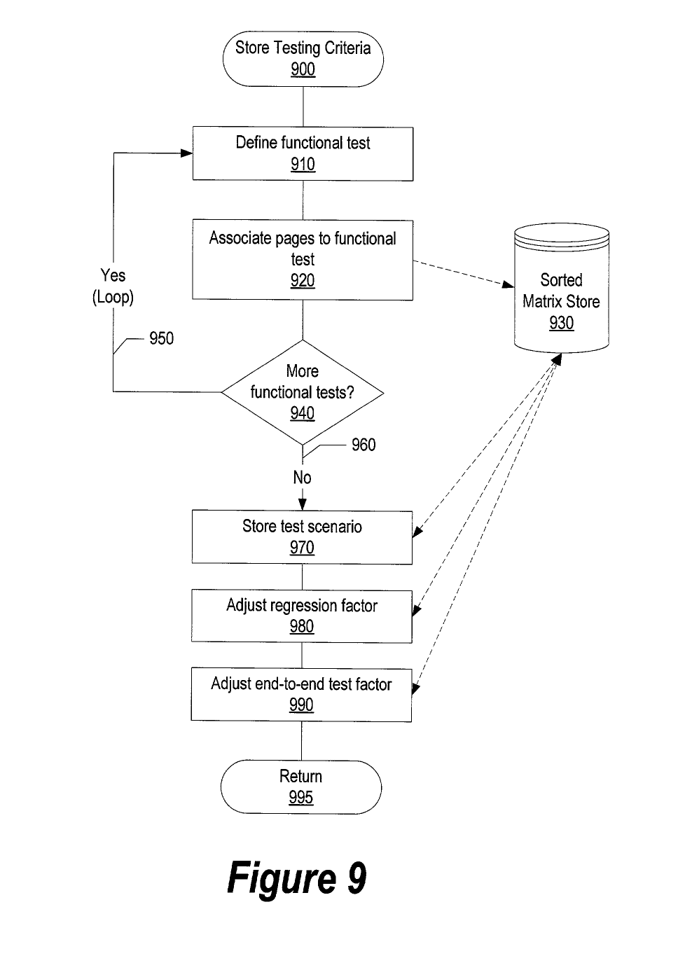

The first occurrence of an executable object in a Web page is identified and stored in sorted matrix store 640 (step 650). For example, an executable object may be used in three different Web pages in which the three Web pages have different completion dates. The Web page that has the earliest completion date may be selected as the Web page in which the executable object occurs first. Testing criteria is stored in sorted matrix store 640 (pre-defined process block 660, see FIG. 9 for further details). A revenue run rate is stored in sorted matrix store 640 at step 670. A run rate may correspond to an hourly rate for an employee. A single run rate may be stored or multiple run rates may be stored. For example, there may be a run rate for creative designers, and a different run rate for object programmers. The run rate may also be based on the complexity of the task. Both rates may be stored in order to generate a more accurate cost for the project. The total effort of the project is validated and refined from a top down perspective at step 680. For example, a project manager may review the final cost of the project and determine that the final cost is more than what a customer is willing to spend. The project manager may refine the project tasks in order to get the final cost consistent with what the customer is willing to pay. The project manager may also set a cost basis and revenue amount (price) in order to analyze and negotiate a gross profit for the project. Processing returns at 690.

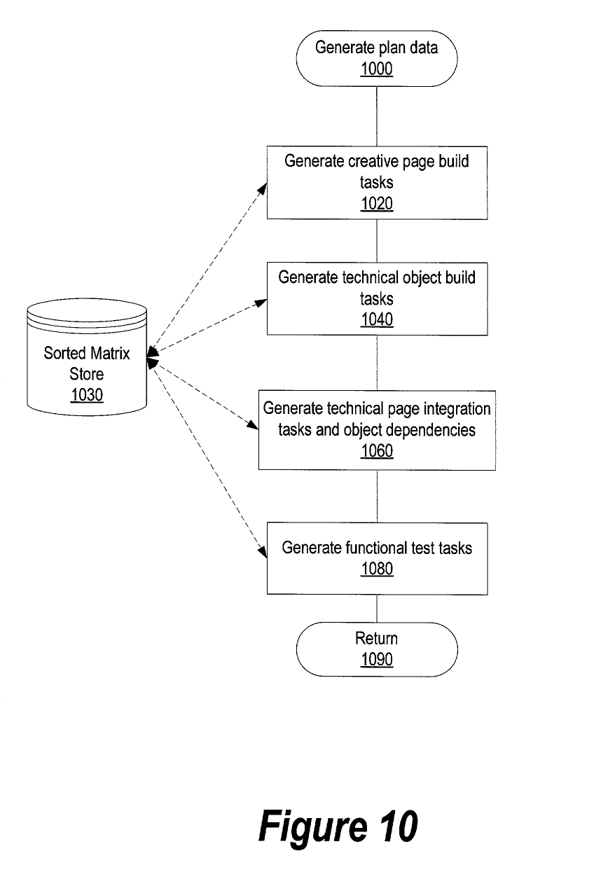

FIG. 7 is a flowchart showing a project plan being generated. Processing commences at 700, whereupon plan data is generated which will be used to generate the project plan (pre-defined process block 710, see FIG. 10 for further details). A first data item is retrieved from sorted matrix store 730 (step 720). For example, the data item may be a page build task, an object build task, or a page integration task. The first retrieved data item is stored in project planning system 750 (step 740). The project planning system may be an off-the-shelf software program, such as IBM's Global System Method Progra™, or a custom project planning system.

A determination is made as to whether there are more data items to retrieve (decision 760). If there are more data items to retrieve, decision 760 branches to “Yes” branch 763 which loops back to retrieve the next data item at step 720. This looping continues until there are no more data items to retrieve, at which point decision 760 branches to “No” branch 767. Deadline dates are assigned to each data item at step 770 and stored in project planning system 750. Output from project planning system 750 is used to generate project planning charts (step 780) and store in data store 790. Processing returns at 795.

FIG. 8 is a flowchart showing a matrix being sorted and various calculations being performed. Processing commences at 800, whereupon data is retrieved from estimator store 820, sorted by an increment value, and stored in sorted matrix store 830 (step 810). For example, the increment value may represent a phase in a schedule corresponding to delivery dates, such as phase one, phase two, or phase three. Data is retrieved from estimator store 820, sorted by total effort, and stored in sorted matrix store 830 (step 840). For example, a project manager may use the total effort sort to organize the larger effort technical tasks and object tasks to the beginning of each page group to quickly rationalize the effort and resource requirements.

A build and integration effort per page is calculated and stored in sorted matrix store 830 (step 850). For example, the first time an object is integrated on a page there will be an effort, or hours, associated with the integration. The calculation determines the integration effort for each page.

The test effort per page is calculated and stored in sorted matrix store 830 at step 860. For example, the number of hours may be calculated to test the home page of a website. The technical effort per object is calculated and stored in sorted matrix store 830 at step 880. The technical effort per object is based on the characteristics of the object. For example if an object is specified as a small object, a lesser amount of effort, or hours, may be applied to complete the object as compared to if it were specified as a large object. Processing returns at 890.

FIG. 9 is a flowchart showing the definition and adjustment of a testing criteria. Processing commences at 900, whereupon a functional test is defined (step 910). For example, a functional test may correspond to a customer adding a product to his shopping cart during online shopping. Pages are associated to the functional test and stored in sorted matrix store 930 (step 920). Using the example described above, the pages that are used during the addition of the product to the shopping cart will be stored in sorted matrix store 930.

A determination is made as to whether there are more functional tests to define (decision 940). If there are more functional test to define, decision 940 branches to “Yes” branch 950 which loops back to define another functional test at step 910. This looping continues until there are no more functional tests to define, at which point decision 940 branches to “No” branch 960 whereupon a test scenario is stored in sorted matrix store 930 (step 970). For example, a user may choose to perform manual testing which corresponds to a certain amount of effort to test each Web page and executable object. Or, the user may choose to perform automated testing which may require more upfront effort, but may require less ongoing effort for each Web page and executable object.

A regression factor is adjusted and stored in sorted matrix store 930 (step 980). The regression factor corresponds to an act of retesting a system and is similar to repeating the functional testing for each phase of the project. For example, regression testing may not be performed in phase one, but may be performed in phase two to retest the functions that were previously tested in phase one. An end-to-end test factor is adjusted and stored in sorted matrix store 930 (step 990). The end-to-end test factor corresponds to how long it will take to build a functional test plan and how long it will take to perform the functional test plan. Processing returns at 995.

FIG. 10 is a flowchart showing a test plan data being generated. Processing commences at 1000, whereupon creative input is retrieved from sorted matrix store 1030, creative page build tasks are generated and stored in sorted matrix store 1030 (step 1020). For example, a creative page build task may include a task to build a Web page. Another example of a creative build task is a creative summary task that corresponds to additional creative macro level activity that needs to be completed. During the generation of a creative page build task, a name is assigned to the task, resources are assigned to the task, the number of hours to complete the task are assigned, and dependencies to other tasks are assigned.

Technical object input is retrieved from sorted matrix store 1030, technical object build tasks are generated and stored in sorted matrix store 1030 (step 1040). For example, a technical object build task may include a task to build an executable object program. Another example of a technical object build task is a technical summary task that corresponds to additional technical macro level activity that needs to be completed. During the generation of a technical object build task, a name is assigned to the task, resources are assigned to the task, the number of hours to complete the task are assigned, and dependencies to other tasks are assigned.

Technical page integration tasks based on page and technical object dependencies are generated and stored in sorted matrix store 1030 (step 1060). For example, a page integration task may be a task to integrate an object into a Web page for the first time. During the generation of a technical page integration build task, a name is assigned to the task, resources are assigned to the task, the number of hours to complete the task are assigned, and dependencies to other tasks are assigned.

Functional test tasks are generated and stored in sorted matrix store 1030 (step 1080). For example, a functional test that was previously defined, such as adding a product to a shopping cart, may have a corresponding functional test task. Processing returns at 1090.

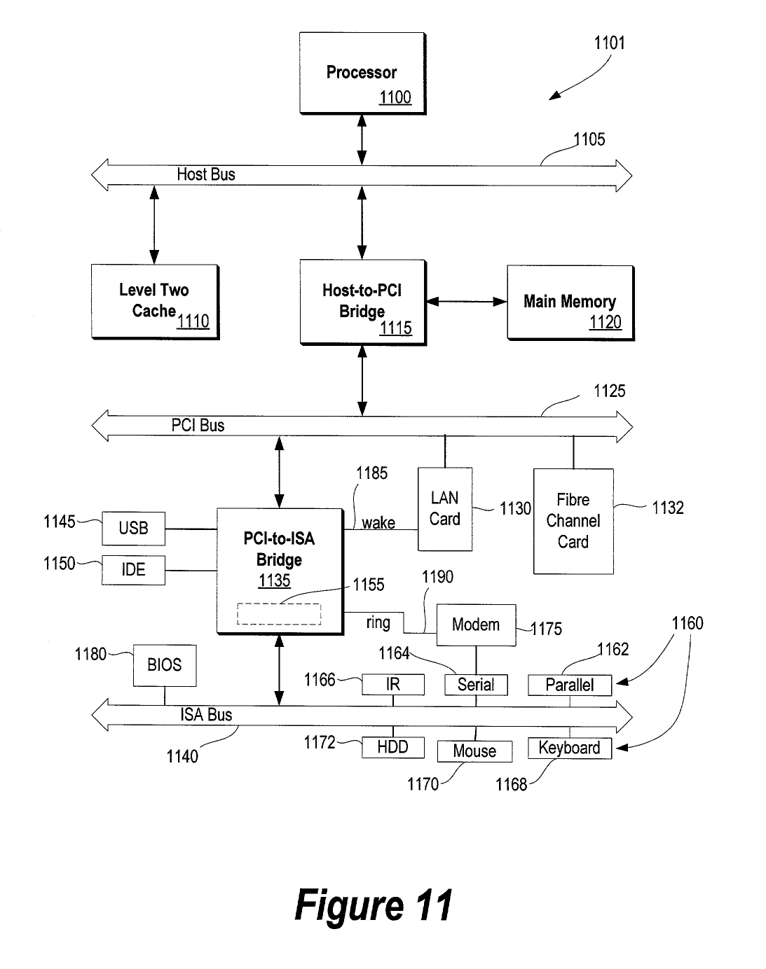

FIG. 11 illustrates information handling system 1101 which is a simplified example of a computer system capable of performing the server and client operations described herein. Computer system 1101 includes processor 1100 which is coupled to host bus 1105. A level two (L2) cache memory 1110 is also coupled to the host bus 1105. Host-to-PCI bridge 1115 is coupled to main memory 1120, includes cache memory and main memory control functions, and provides bus control to handle transfers among PCI bus 1125, processor 1100, L2 cache 1110, main memory 1120, and host bus 1105. PCI bus 1125 provides an interface for a variety of devices including, for example, LAN card 1130. PCI-to-ISA bridge 1135 provides bus control to handle transfers between PCI bus 1125 and ISA bus 1140, universal serial bus (USB) functionality 1145, IDE device functionality 1150, power management functionality 1155, and can include other functional elements not shown, such as a real-time clock (RTC), DMA control, interrupt support, and system management bus support. Peripheral devices and input/output (I/O) devices can be attached to various interfaces 1160 (e.g., parallel interface 1162, serial interface 1164, infrared (IR) interface 1166, keyboard interface 1168, mouse interface 1170, and fixed disk (HDD) 1172) coupled to ISA bus 1140. Alternatively, many I/O devices can be accommodated by a super I/O controller (not shown) attached to ISA bus 1140.

BIOS 1180 is coupled to ISA bus 1140, and incorporates the necessary processor executable code for a variety of low-level system functions and system boot functions. BIOS 1180 can be stored in any computer readable medium, including magnetic storage media, optical storage media, flash memory, random access memory, read only memory, and communications media conveying signals encoding the instructions (e.g., signals from a network). In order to attach computer system 1101 to another computer system to copy files over a network, LAN card 1130 is coupled to PCI bus 1125 and to PCI-to-ISA bridge 1135. Similarly, to connect computer system 1101 to an ISP to connect to the Internet using a telephone line connection, modem 1175 is connected to serial port 1164 and PCI-to-ISA Bridge 1135.

While the computer system described in FIG. 11 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for scheduling software development, said method comprising:
analyzing a plurality of display page definitions, wherein one or more of the display page definitions corresponds to one or more executable object definitions;
identifying one or more dependencies between the display page definitions and the executable object definitions; and
generating a project plan in response to the identified dependencies.

2. The method as described in claim 1 wherein each display page definition includes a display page identifier, and wherein each executable object definition includes an executable object identifier.

3. The method as described in claim 1 further comprising:
gathering technical input for one or more of the executable object definitions, wherein the technical input is selected from the group consisting of an object size, an architecture, a micro build percentage, and a page integration time.

4. The method as described in claim 1 further comprising:
gathering creative input for each display page definition, wherein the creative input is selected from the group consisting of a completion requested stage, a difficulty factor, a creative complexity factor, and a creative macro input.

5. The method as described in claim 1 further comprising:
identifying a first display page definition corresponding to one of the executable object definitions;
setting a display page schedule date corresponding to the first display page definition; and
determining an executable object schedule date corresponding to the identified executable object definition based on the display page schedule date.

6. The method as described in claim 1 wherein the generating further includes:
providing an expected page completion date for each display page definition and an expected object completion date for each executable object definition;
integrating one or more of the display page definitions with one or more of the executable object definitions, the integrating resulting in one or more integration tasks; and
providing an expected integration completion date for each of the integration tasks.

7. The method as described in claim 6 further comprising:
receiving a project start date; and
calculating a project duration based upon the project start date and the expected integration completion dates.

8. The method as described in claim 6 further comprising:
determining an expected integration start date for each integration task based upon the integrating; and
preparing an integration test schedule for each integration task based upon the expected integration start date and the expected integration completion date for the corresponding integration task.

9. The method as described in claim 1 wherein at least one of the display page definitions includes a Web page.

10. The method as described in claim 1 further comprising:
receiving a display page revenue run rate;
receiving an executable object revenue run rate;
calculating a display page total effort;
calculating an executable object total effort; and
calculating a project cost based on the display page revenue run rate, the executable object revenue run rate, the display page total effort, and the executable object total effort.

11. An information handling system comprising:
one or more processors;
a memory accessible by the processors;
one or more nonvolatile storage devices accessible by the processors;
a website development scheduling tool to schedule software development, the website development scheduling tool including:
means for analyzing a plurality of display page definitions, wherein one or more of the display page definitions corresponds to one or more executable object definitions;
means for identifying one or more dependencies between the display page definitions and the executable object definitions; and
means for generating a project plan in response to the identified dependencies.

12. The information handling system as described in claim 11 wherein each display page definition includes a display page identifier, and wherein each executable object definition includes an executable object identifier.

13. The information handling system as described in claim 11 further comprising:
means for gathering technical input for one or more of the executable object definitions, wherein the technical input is selected from the group consisting of an object size, an architecture, a micro build percentage, and a page integration time.

14. The information handling system as described in claim 11 further comprising:
means for gathering creative input for each display page definition, wherein the creative input is selected from the group consisting of a completion requested stage, a difficulty factor, a creative complexity factor, and a creative macro input.

15. The information handling system as described in claim 11 further comprising:
means for identifying a first display page definition corresponding to one of the executable object definitions;
means for setting a display page schedule date corresponding to the first display page definition; and
means for determining an executable object schedule date corresponding to the identified executable object definition based on the display page schedule date.

16. The information handling system as described in claim 11 wherein the means for generating further includes:
means for providing an expected page completion date for each display page definition and an expected object completion date for each executable object definition;
means for integrating one or more of the display page definitions with one or more of the executable object definitions, the integrating resulting in one or more integration tasks; and
means for providing an expected integration completion date for each of the integration tasks.

17. The information handling system as described in claim 16 further comprising:
means for receiving a project start date; and
means for calculating a project duration based upon the project start date and the expected integration completion dates.

18. The information handling system as described in claim 16 further comprising:
means for determining an expected integration start date for each integration task based upon the integrating; and
means for preparing an integration test schedule for each integration task based upon the expected integration start date and the expected integration completion date for the corresponding integration task.

19. The information handling system as described in claim 11 wherein at least one of the display page definitions includes a Web page.

20. The information handling system as described in claim 11 further comprising:
means for receiving a display page revenue run rate;
means for receiving an executable object revenue run rate;
means for calculating a display page total effort;
means for calculating an executable object total effort; and
means for calculating a project cost based on the display page revenue run rate, the executable object revenue run rate, the display page total effort, and the executable object total effort.

21. A computer program product stored in a computer operable media for scheduling software development, said computer program product comprising:
means for analyzing a plurality of display page definitions, wherein one or more of the display page definitions corresponds to one or more executable object definitions;
means for identifying one or more dependencies between the display page definitions and the executable object definitions; and
means for generating a project plan in response to the identified dependencies.

22. The computer program product as described in claim 21 wherein each display page definition includes a display page identifier, and wherein each executable object definition includes an executable object identifier.

23. The computer program product as described in claim 21 further comprising:
means for gathering technical input for one or more of the executable object definitions, wherein the technical input is selected from the group consisting of an object size, an architecture, a micro build percentage, and a page integration time.

24. The computer program product as described in claim 21 further comprising:
means for gathering creative input for each display page definition, wherein the creative input is selected from the group consisting of a completion requested stage, a difficulty factor, a creative complexity factor, and a creative macro input.

25. The computer program product as described in claim 21 further comprising:
means for identifying a first display page definition corresponding to one of the executable object definitions;
means for setting a display page schedule date corresponding to the first display page definition; and
means for determining an executable object schedule date corresponding to the identified executable object definition based on the display page schedule date.

26. The computer program product as described in claim 11 wherein the means for generating further includes:
means for providing an expected page completion date for each display page definition and an expected object completion date for each executable object definition;
means for integrating one or more of the display page definitions with one or more of the executable object definitions, the integrating resulting in one or more integration tasks; and
means for providing an expected integration completion date for each of the integration tasks.

27. The computer program product as described in claim 26 further comprising:
means for receiving a project start date; and
means for calculating a project duration based upon the project start date and the expected integration completion dates.

28. The computer program product as described in claim 26 further comprising:
means for determining an expected integration start date for each integration task based upon the integrating; and
means for preparing an integration test schedule for each integration task based upon the expected integration start date and the expected integration completion date for the corresponding integration task.

29. The computer program product as described in claim 21 wherein at least one of the display page definitions includes a Web page.

30. The computer program product as described in claim 21 further comprising:
means for receiving a display page revenue run rate;
means for receiving an executable object revenue run rate;
means for calculating a display page total effort;
means for calculating an executable object total effort; and
means for calculating a project cost based on the display page revenue run rate, the executable object revenue run rate, the display page total effort, and the executable object total effort.
